(19) United States
(12) Patent Application Publication
(10) Pub. No.: US 2007/0039899 A1
(43) Pub. Date: Feb. 22, 2007

(54) Thickener for concentration of fibre suspensions

(75) Inventors: Anders Bergdahl, Sundsbruk (SE); Lars-Ake Lindstrom, Sundsvall (SE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Metso Paper, Inc., Helsinki (SE)

(21) Appl. No.: 10/573,142

(22) PCT Filed: Aug. 17, 2004
(86) PCT No.: PCT/SE04/01204

§ 371 Date: Oct. 26, 2006

(30) Foreign Application Priority Data
Sep. 24, 2003 (SE) 0302530-1

(51) Int. Cl. C02F 1/00

(52) U.S. Cl. 210/780

(57) ABSTRACT

A thickener for concentrating fiber suspensions is disclosed including a housing, a rotor arranged on the housing, a screen attached to the rotor for separating the fiber suspension into a first fraction passing through the screen substantially containing only fibers and a fraction not passing through the screen and containing coarse undesired particles, a stationary thickener surrounding the rotor and provided with through holes and supply conduits for supplying the first fraction to the stationary thickener for separating that fraction into a fraction passing through the holes in the stationary thickener and a separate fraction not passing through the holes in the stationary thickener. The through holes are dimensioned such that substantially only liquid is permitted to pass through the stationary thickener and the fraction which does not pass through the through holes comprises the thickened fiber pulp free of the undesired coarse particles.

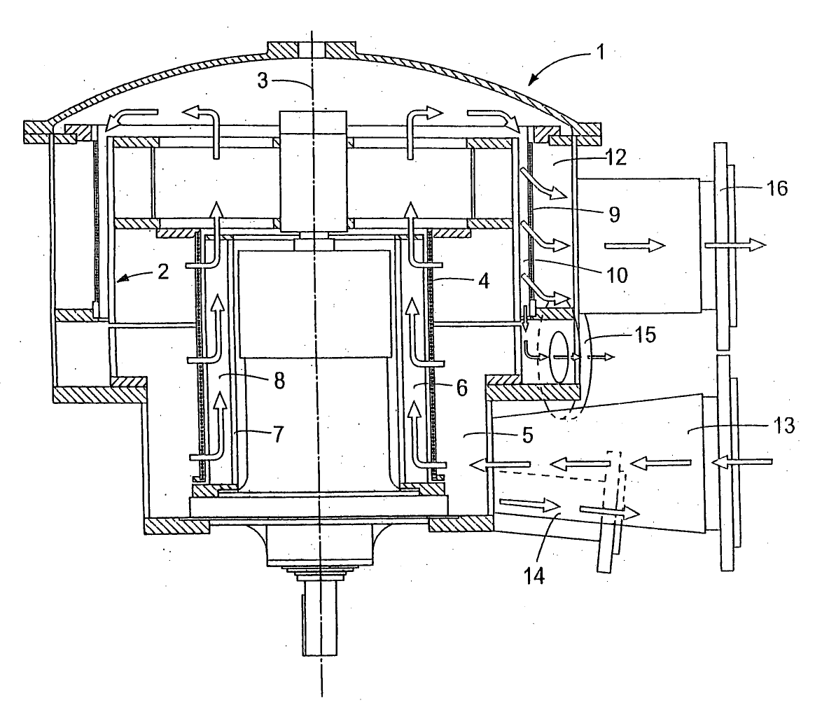

The present invention relates to a thickener for concentration of a fibre suspension containing relatively coarse undesired particles.

In the pulp production industry fibre pulp suspensions are treated in several subsequent process steps, each process step comprising separate process equipment. As many pumps as process steps are required for the transportation of the fibre pulp suspension as the suspension is being treated in the respective process steps. A plurality of such process steps is typically constituted by a series of thickening and washing steps, in which the fibre pulp suspension is concentrated and washed.

To prevent apparatuses in the thickening and washing steps from being damaged by coarse particulate contaminates the fibre pulp suspension first is screened in one or more screening steps. The screening of the fibre pulp suspension is normally carried out at relatively low fibre concentrations of the suspension, lower than 5%. The thickening apparatus in a first thickening step directly after the last screening step thus receives a fibre pulp suspension having a relatively low fibre concentration.

Since the capacity of traditional thickening apparatuses often is related to the fibre concentration of incoming fibre pulp suspension it is common practice to design the first thickening step with a relatively large capacity to be capable of handling the relatively large flow of the fibre suspension fed to the first thickening step. This results in the disadvantage that the thickening apparatus of the first thickening step will be large and space demanding. A way of eliminating this disadvantage has been to install a separate pre-dewatering apparatus between the last screening step and the first thickening step. Of course, such a pre-dewatering apparatus requires an additional pump.

The object of the present invention is to provide a thickener that rationalizes the above described process steps and eliminates the need for designing the first thickening step larger than the subsequent thickening steps, or, alternatively, eliminates the need for installing a separate pre-dewatering apparatus.

This object is obtained by a thickener comprising a housing, a rotor arranged in the housing, a screen member attached to the rotor and having screen passages dimensioned for separating the fibre suspension into a first fraction of the fibre suspension passing through the screen member and substantially containing fibres, and a second fraction not passing through the screen member and containing the coarse undesired particles, a stationary thickening member surrounding the rotor and provided with a multiplicity of through holes, and means arranged in the housing for supplying the first fraction of the fibre suspension to the thickening member, so that the thickening member separates the first fraction into a third fraction passing through the holes of the thickening member, and a fourth fraction not passing through the holes of the thickening member, wherein the holes of the thickening member are dimensioned such that liquid but not fibres is allowed to pass through the thickening member, whereby the fourth fraction of the fibre suspension produced during operation is constituted by thickened fibre pulp free from undesired coarse particles.

As a result, an integrated apparatus is obtained capable of separating undesired particulate contaminates that could damage subsequent process equipment, for example thickening apparatuses, and of providing thickening of the fibre pulp suspension that eliminates the need for designing the first thickening step with a larger capacity than the subsequent thickening steps, or alternatively, eliminates the need for installing a separate pre-dewatering apparatus with a necessary pump. In addition to this, the energy consumption is reduced, since the separation of coarse particles and thickening of the fibre pulp suspension can be integrated in one and the same apparatus.

According to a preferred embodiment of the invention, the screen member is tubular and coaxially attached to the rotor. The stationary thickening member is also tubular and surrounds the rotor coaxially with the latter.

The fibre suspension to be thickened by the thickener according to the invention preferably has a fibre concentration in the range of 0.5-5%.

The invention is described in more detail in the following with the reference to the accompanying drawing, which shows a cross-section through a thickener according to the invention.

The drawing shows a thickener according to the invention intended for thickening of fibre suspensions, preferably fibre pulp suspensions, containing relatively coarse undesired particles. The thickener comprises a pressurized housing 1 and a rotor member 2 arranged in the latter and rotatable about a rotor axis 3. A first tubular screen member 4 is coaxially attached to the rotor member 2 there is provided, whereby the screen member 4 rotates as the rotor member 2 rotates. The rotatable screen member 4 divides the interior of the housing 1 into a first inlet chamber 5 outside the rotatable screen member 4 and a first outlet chamber 6 within the tubular screen member 4. To obtain strong centrifugal forces as an aid when separating heavier particles out of the fibre suspension to be separated, the first inlet chamber 5 should not be too large. The first inlet chamber is inwardly limited by a stator 7 with one or more stationary pulse members 8 arranged in the inside of the rotatable screen member 4. The rotatable screen member 4 and stator 7 are coaxially arranged. The pulse members 8 are adapted to create suction pulses when the rotatable screen member 4 rotates. The suction pulses help,to conduct the first fraction of the fibre suspension from the first inlet chamber 5 and into the first outlet chamber 6.

The rotatable screen member 4 with the first inlet chamber 5, the first outlet chamber 6 and stator 7 constitute a screening step.

In the upper part of the housing 1 there is a tubular thickening member 9, which is stationary. The stationary thickening member 9 divides the interior of the housing 1 so that a second inlet chamber 10 is formed inside the stationary thickening member 9 and a second outlet chamber 12 is formed outside the stationary thickening member 9.

The stationary thickening member 9, the second inlet chamber 10 and the second outlet chamber 12 constitute a thickening step.

The rotatable screen member 4 may be any type of screen member with screen openings of suitable sizes to accept fibres and reject coarse particles. For example, the screen member 4 may have slots with openings between 0.1 mm and 0.5 mm or holes having diameters between 0.1 mm and 12 mm. The stationary thickening member 9 has through holes that permit dewatering of the first fraction of the fibre suspension without passing through fibres of desired size. For example, the stationary thickening member 9 may have holes with a diameter between 0.1 mm-1.2 mm, suitably 0.2-1.0 mm and preferably 0.3-0.8 mm.

The largest diameter of the inlet chamber 5 is smaller than the smallest diameter of the second inlet chamber 10. This enables the first inlet chamber 5 to be partially arranged within the second inlet chamber 10. In the embodiment shown the inner delimiting surface of the second inlet chamber 10 has a cylindrical shape and the inner delimiting surface of the first inlet chamber 5 has likewise a cylindrical shape. Of course, they may also take other shapes, such as conical shape.

Thus, the screening step is at least partially arranged inside the thickening step and, consequently, the rotatable screen member 4 is at least partially arranged inside the stationary thickening member 9 (telescopically). The rotatable screen member 4 has a substantially smaller diameter than the stationary thickening member 9. Already a diameter, which is 25% smaller than the stationary thickening member 9, gives significantly reduced energy consumption. However, the diameter of the rotatable screen member 4 is suitably at least 35% smaller preferably up to 50% smaller than the diameter of the stationary thickening member 9. To make possible that the screening step will have as much capacity as the thickening step the first screening step can be designed relatively high without changing the total height of the thickener.

The fibre pulp suspension to be thickened is supplied through an inlet member 13 to the first inlet chamber 5, so that the fibre suspension separates into said first fraction of the fibre suspension that passes through the rotatable screening member 4 and substantially contains fibres, and a second fraction of the fibre suspension that does not pass through the rotatable screening member and contains coarse undesired particles. The second fraction is discharged from the inlet chamber through a reject outlet 14. The first fraction of the fibre suspension flows upwardly through the first outlet chamber 6 and out through an outlet in the top portion thereof. Then, the first fraction flows further upwardly within the rotor member 2 and out above the latter. Therefrom it flows downwards into the second inlet chamber 10.

The first fraction that flows into the second inlet chamber 10 is thickened by the stationary thickening member 9 into a third fraction that passes through the holes of the thickening member 9 and substantially contains water and a portion of small fibre fragments, and a fourth fraction that does not pass through the thickening member 9 and contains thickened fibre pulp. The formed thickened fibre pulp is discharged from the second inlet chamber 10 through an outlet member 15, whereas separated water is discharged from the second outlet chamber 12 through an outlet member 16.

Of course, the invention is not limited to the embodiment shown but can be varied within the, scoop of the claims with reference to the description and drawing.

1. A thickener for concentration of a fiber suspension containing relatively coarse undesired particles, comprising:
a housing,
a rotor arranged in said housing,
a screen member attached to said rotor and g including screen passages dimensioned for separating said fiber suspension into a first fraction said fiber suspension passing through said screen member and substantially containing fibers, and a second fraction not passing through said screen member and containing said coarse undesired particles,
a stationary thickening member surrounding at least a portion of said rotor and provided with a multiplicity of through holes, and
supply means arranged in the housing for supplying said first fraction of said fiber suspension to said stationary thickening member, whereby said stationary thickening member can separate said first fraction into a third fraction passing through said multiplicity of through holes in said stationary thickening member, and a fourth fraction not passing through said multiplicity of through holes in said stationary thickening member, said multiplicity of through holes being dimensioned such that substantially only liquid is permitted to pass through said stationary thickening member, and said fourth fraction of said fiber suspension comprises thickened fiber pulp free of said undesired coarse particles.

2. A thickener according to claim 1, wherein said screen member is tubular and is coaxially attached to said rotor.

3. A thickener according to claim 1, wherein said stationary thickening member is tubular and coaxially surrounds said rotor.

4. A thickener according to claims 1, wherein said fiber suspension to be thickened has a fiber concentration in the range of 0.5 to 5%.
